(19) United States
(12) Patent Application Publication
(10) Pub. No.: US 2008/0296219 A1
(43) Pub. Date: Dec. 4, 2008

(54) Atmospheric bioremediation system and method

(76) Inventor: Robert D. Adams, Cinnaminson, NJ (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 11/809,811

(22) Filed: Jun. 1, 2007

(51) Int. Cl. C02F 3/32

(52) U.S. Cl. 210/602; 210/170.05

(57) ABSTRACT

An atmospheric bioremediation system and method uses preformed gel-like agar sheets or equivalent biological growth medium, composed to selectively enhance the growth of microalgae in defined environmental conditions. Agar is heated and liquefied and soluble iron is added to the agar in predetermined proportions. The agar solution is also modified for salinity concentration and ph in order to conform to the levels found in the marine environment to which the agar sheets are to be introduced. This is done in order to provide a slow-time release of the iron to prevent premature precipitation. Also, the osmotic variance needs to be equalized by salinity concentration and ph adjustment to prevent premature osmotic migration of the iron molecules when in gel form. Once formed, the gel sheets are transported to defined bodies of water, e.g. areas of the ocean, by marine vessels, preferably in seagoing containers, where they are systematically released onto the water's surface, to help stabilize any surface turbulence. Microalgae growth will be initiated by the iron content and sustained and mechanically stabilized by the agar sheets. Since agar sheets float, they will remain at the surface, facilitating monitoring and mechanical control of the resulting biomass. Containment booming can be used to provide boundaries in which the sheets are located.

### BACKGROUND OF THE INVENTION

Beginning during the Industrial Revolution and increasing exponentially over the last two centuries, tremendous amounts of heat-trapping gases and man-made pollutants have been emitted into the earth's atmosphere. The continued and accelerated burning of fossil fuels, especially, has resulted in the accumulation of dangerous gases, primarily carbon dioxide which prevents heat from escaping the atmosphere. This phenomenon, commonly known as the “greenhouse effect,” has lead to global warming, now recognized as a real and significant threat to the earth and its inhabitants.

It would appear that the only process with enough global power to work to reduce this massive build-up of greenhouse gases is managed exploitation of the ongoing biological processes already at work, which daily remove massive amounts of carbon dioxide from the earth's atmosphere.

Ocean micro-algae (phytoplankton) are known to consume massive amounts of carbon dioxide and emit massive amounts of oxygen during metabolic photosynthesis, via chlorophyll. Iron is known to stimulate algae metabolism, growth, and reproduction, and in past studies of ocean biology, the experimental application of soluble iron solution on defined areas of the ocean's surface relatively devoid of algae but nutrient rich, has resulted in extremely rapid and substantial algae blooms.

The present invention is concerned with the removal of billions of tons of the greenhouse gas, carbon dioxide, over a period of ten or more years. This involves the large scale seeding (multiple square miles) of defined ocean surfaces with iron in order to stimulate enough additional ocean micro-algae growth to consume billions of tons of anthropogenic carbon dioxide, removing it from earth's atmosphere.

The effects on the ocean ecosystem of massive amounts of carbon dioxide laden, iron enriched algae dying off and sinking to the ocean's floor are not fully known; they may potentially create more ecological problems than they solve. Therefore, an essential component of the present invention involves the removal of spent algae, at the end of its useful lifecycle, by the commercial operation of harvesting the algae for processing into an eco-friendly biofuel, namely, biodiesel.

Biodiesel from ocean algae is considered a much more efficient biofuel than any other type. The reason for this is that the algae does not compete agriculturally or commercially with food crop production, as do other biofuel plant source crops, and it does not require massive land areas, as do other biofuel plant sources. In addition, algae contains 30 to 40 times more oil than other biofuel plant sources and it can be used in existing diesel engines without any modifications. Biodiesel also has a solvent effect on moving mechanical parts which reduces maintenance and prolongs the useful life of diesel engines.

Biodiesel is considered non-volatile. It has a flash-point 300 degrees Fahrenheit higher than petroleum based fuels, and is therefore safer to handle, transport, and will not ignite during vehicle accidents. Biodiesel burns cleaner than petroleum fuels, emitting 80% less carbon dioxide, 100% less sulfur, and 90% less unburned hydrocarbons, and it has 75 to 90% less aromatic hydrocarbon release. The exhaust from biodiesel engines smells like popcorn.

Biodiesel can utilize existing infrastructure for product distribution and retail dispensing (petrol stations). It can be used as heating oil for homes and businesses, and it has industrial heating applications. Useful by-products include glycerol, used in soaps and cosmetics, and high nitrogen content fertilizer. Other products, such as cooking oils, certain cereals, and vitamins, all processed from algae-high in omega 3, could also be produced in abundance.

There are several methods for removing the algae biomass from the ocean's surface, so as to recover this algae for processing into biodiesel. One way would be to simply vacuum up the surface mass with large volume pumps attached to barges and/or tanker ships, which would strain the algae and drain the residual water, and then transport the payload to land-based processing centers, subsequently transforming the raw material, the algae, into biodiesel fuel.

Another method would be to rig the same vessels with systems of large skimmers and conveyor belts, as is done in oil-spill cleanup operations. Such systems would skim the surface at one end, and transport the algae up to the vessel's hold at the other end, while simultaneously draining off excess water.

The system and method of the present invention, however, is vastly preferred. It is efficient, effective and does not require the intensive use of expensive ships fitted with specialized equipment.

From a macro-biological standpoint, the resultant increase in marine life from the massive algae growth and removal (some algae loss will be due to feeding activity by zooplankton, which are then consumed by fish and some species of marine mammals) should help to restore the decimated fishing industry, as well as marine species populations.

### SUMMARY OF THE INVENTION

Agar is a commonly used laboratory biological growth medium which is helpful in the identification and culturing of microorganisms. It is made from red algae and can be constituted into a strong gel by heating and then cooling. Agar becomes a gel at approximately 89.6 degrees Fahrenheit.

The present invention comprises a system and method using preformed gel-like agar sheets or equivalent biological growth medium, composed to selectively enhance the growth of microalgae in defined environmental conditions. Agar is heated and liquefied and soluble iron is added to the agar in predetermined proportions. The agar solution is also modified for salinity concentration and ph in order to conform to the levels found in the marine environment to which the agar sheets are to be introduced. This is done in order to provide a slow-time release of the iron to prevent premature precipitation. Also, the osmotic variance needs to be equalized by salinity concentration and ph adjustment to prevent premature osmotic migration of the iron molecules when in gel form.

Once formed, the gel sheets are transported to defined bodies of water, e.g. areas of the ocean, by marine vessels, preferably in seagoing containers, where they are systematically released onto the water's surface, to help stabilize any surface turbulence. Microalgae growth will be initiated by the iron content and sustained and mechanically stabilized by the agar sheets. Since agar sheets float, they will remain at the surface, facilitating monitoring and mechanical control of the resulting biomass. Containment booming can be used to provide boundaries in which the sheets are located.

The agar sheets can be constituted with a variety of growth enhancing elements and compounds, as well as antibiotics in order to tailor the sheets to selectively optimize the growth of particular species of algae such as botryococcus braunii, which oils can be converted to octane, e.g. fuels, gasoline, kerosene, and aircraft grade fuels, as well as biodiesel, or phaeocystis antarctica, which take up twice the carbon dioxide volume compared to other strains, or even a hybridization of the two species.

The agar sheets can also be constituted to provide a medium for phytoremediation applications, such as the cleanup of contaminated soils, lakes, or ponds, etc.

The production of agar sheets may be preformed at land-based production facilities or aboard marine vessels appropriately equipped with heating tanks, forming molds, etc. Agar in bulk-powdered form may be intermixed with the soluble iron solution and the seawater pumped in from “on-site”, and manufactured and distributed, potentially in assembly line fashion. It may also be possible to spray the liquid agar solution from such marine vessels directly onto the ocean surface to create a gelatinous film. The film would then become the biological growth medium around which microalgae will form and grow.

At the conclusion of the algae growth cycle, the prefabricated agar sheets may be separated from the microalgae growth at the harvesting facility and reconstituted, and the material easily recycled and reused, as is facilitated by agar's unique characteristics of hysteresis (transition temperatures). The recovered algae is then forwarded for processing as biodiesel.

The bioremediation system and method of the present invention would necessarily need to factor in the ideal locations for algae farming operations, as well as the volume of area needed to remove the target amount of carbon dioxide from the atmosphere.

The ocean surfaces comprising areas of high nutrient, low-iron/low-algae concentration is estimated to cover approximately 20% of the earth's oceans surface area. This amounts to approximately 27,782,060 square miles potentially available for accelerated algae aquaculture operations.

Recent NASA satellite mapping of chlorophyll concentrations in the earth's oceans displays a massive area of the South Pacific with very low chlorophyll concentrations, which correlates to very low amounts of algae growth. By using areas relatively devoid of algae, there is little or no interference with existing marine food chain processes.

Based on previous results of scientific experimental iron seeding and the resulting sudden algae blooms, the amount of carbon dioxide consumed by one square mile of surface algae is approximately 1300 tons per year. Therefore, the required surface area of algae fields needed to consume 1 billion tons of carbon dioxide from the atmosphere per year is approximately 770,000 square miles.

However, when algae absorb carbon dioxide from the atmosphere, it also exchanges oxygen for the carbon dioxide on almost a one to one basis. Actually, ocean-algae produce between 50% and 80% of the oxygen replenishing the earth's atmosphere on a daily basis. This process effectively dilutes the density of the atmospheric concentration of carbon dioxide (lower ppm.), and therefore the resulting higher levels of oxygen from the system of the present invention must also be considered.

With reduced concentrations of carbon dioxide in the atmosphere due to the dilution effect, coupled with the physical removal of millions of tons of carbon dioxide annually, a point will be reached where the actual tonnage of removed carbon dioxide, while somewhat less than one billion per year, will have the net effect of reducing the greenhouse effect dynamics (by the counter-balancing of these elements), and will produce essentially the same desired effect as the target reduction amount, i.e. 1 billion tons per year.

Of course, this formula needs to be refined; however this variable indicates that significantly less square miles of algae coverage will be required to reach the target reduction amount in terms of achieving the desired net effect. It is estimated that approximately 500,000 square miles should probably be the starting point.

It will be desirable for the algae field(s) to remain relatively intact during periods of rough water and wind conditions. Therefore, a method of containment will need to be employed, such as the pre-deployment of floating containment booms similar to the ones used to contain accidental oil-spills. These can be transported to the site by ship and deployed from large reels, also as is currently used in the oil-spill mitigation services industry, which creates a containment boundary to prevent the algae fields from dispersing. These flexible booms can be repeatedly repositioned to conform to the boundary line as needed and as weather conditions or seasonal current fluctuations warrant.

By the formulation of a “seeding solution” made up of the correct percentages of soluble iron and agar, and the dispersal of this solution, there will be more of a time-release of the iron. And by forming a gelatinous film or sheet, unused iron will be prevented from participating-out, while at the same time, helping the algae to grow from the stabilizing mechanics of the agar. Also, this composition should help the algae stay together in a cohesive floating mass, like billions of tiny bits of fruit in a giant bowl of Jello®.

In a preferred alternative method of algae removal, the algae recovery procedure can be facilitated by introducing the algae growth fields to a location where low-iron/low-algae densities also coincide with an area of the ocean where relatively consistent directional ocean surface currents exist. The containment booms can be aligned along the contours of ocean current lines (somewhat parallel to the directional flow) and can then be “funneled” down to the coastal areas where the land-based algae processing facilities are located.

The surface currents would automatically transport the algae fields, like a “message in a bottle” carbon dioxide conveyor belt, to the site of the processing centers, where they can be retrieved via conveyor apparatus or pumps on-shore. The ships would only be needed to monitor the positions of the containment booms, since the booms themselves can be anchored to the ocean floor.

The South Pacific Circulation appears to surround the single largest, as well as lowest-density algae growth area in the world, about the size of the Mediterranean Sea—approx. 1,000,000 sq. mi. Within these currents there appears to be a subtropical wave driven convergence stream about 6,000 miles off the coast of Chile, beginning at 140 degrees w., 20 degrees s., running southeast to about 50 degrees s. where the currents curve northeast toward the southern coast of Chile.

This subtropical area of low-algae population appears to be a prime location to initiate the system and method of the invention, and of establishing a continuous “conveyor belt” of algae which, by way of these counter-clockwise ocean currents, can be funneled down to land-based processing centers situated at sites, such as along the south Chilean coast. Processing centers may also be situated along the coasts of Australia and New Zealand, as well as on certain South Pacific islands, which would provide alternative production locations, should adverse conditions affect any particular host site.

The algae fields could be reshaped, or “herded”, and spiraled off, using the containment booms, from the central biomass, to areas where the south equatorial current of the South Pacific Circulation could similarly transport the algae to additional or alternative host “landing” areas.

As previously discussed, harvested algae can be used as a significant source of biodiesel fuel. Biodiesel is produced by a process called transesterification. Such fuels are currently being produced in volume, such as at the DeBeers Fuel Ltd. bioreactor plant in South Africa. Similar production facilities on a much larger scale can be located near the source of the ocean algae harvesting operations, and should be capable of producing multi-millions of barrels of biodiesel fuel annually.

Algae processing facilities can be replicated in additional host locations such as Australia and New Zealand, as well some South Pacific islands. The algae field may then simply be repositioned and spiraled off to the north-northwest quadrant toward the South Pacific's subequatorial surface currents of the same subtropical circulation, as a potential failsafe against adverse conditions arising in one or another host locations.

Since the raw material used in the system and method of this invention is virtually cost free, except for seeding, conveying, and harvesting expenses, and biodiesel production technology, through economies of scale, is neither complex nor labor intensive, the per liter price of the fuel should become more than competitive with petroleum based fuels, and consumer demand should increase exponentially as the ecological benefits of biodiesel become more known on a widespread basis. In fact, super-mass production volumes will be required to meet the growing demand. Since super-mass volumes of the feed material is available, biodiesel has the potential to eventually supplant most, if not all, of the current and future fossil fuel consumption on a global basis.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an illustration of the manner of storage and delivery from a container of agar sheets in accordance with the present invention.

FIG. 2 is a representation of the manner of disbursement of agar sheets from a marine vessel, in accordance with the present invention.

FIG. 3 is an overhead view of an agar sheet field with individual sheets distributed in a body of water.

FIG. 4 is an overhead view of the agar sheet field in FIG. 3, several days after deployment of the sheets.

FIG. 5 is an overhead view of the agar sheet field in FIG. 3, approximately one week after deployment of the sheets.

FIG. 6a to 6c are elevation views of an agar sheet approximately ten hours, twenty hours, and thirty hours after deployment of the sheet.

### DETAILED DESCRIPTION OF THE INVENTION

Agar is a gelatinous substance chiefly used as a culture, biological growth medium. It is made from red algae. Agar can be constituted as a gel by the process of first heating it to a liquefied state and then cooling it at approximately 89.6 degrees Fahrenheit. For purposes of the present invention, after heating, soluble iron, which will stimulate microalgae growth, is added to the liquid agar. It is anticipated that a variety of growth enhancing elements and compounds and antibiotics will also be added to the liquid agar, to selectively optimize the growth of particular species of algae.

The resulting agar composition is cooled in molds to produce pre-form sheets 2 of agar. Sheets 2 of hardened gelatinous composition are sized to fit into standard transport containers 4. Sheets 2 are relative lightweight and they will float on the water's surface.

The current invention should not be considered restricted to the use of agar as the growth medium. Other growth mediums which consist of a variety of types of algae could also be employed in lieu of agar.

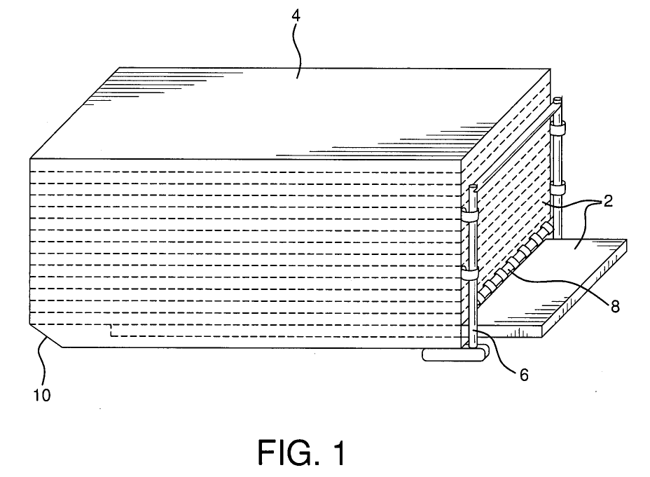

Container 4, as seen in FIG. 1, is configured to house a plurality of stacked agar sheets 2. Container 4 comprises discharge system 6, which permits dispensing one agar sheet 2 or multiple sheets at a time. As lower door 8 at the bottom of system 6 is raised to the height of a single agar sheet 2, that sheet is expelled from container 4. Beveled bottom end 10 of container 4 assists in directing agar sheets 2 out of the container. After one agar sheet 2 is dispensed, the next sheet in the stack drops to the bottom of container 4 and is similarly expelled. This process continues until all agar sheets 2 have been dispensed from container 2. It is contemplated that door system 6 can be operated and opened mechanically using cables, rods, hydraulics or equivalent systems and can be actuated manually or remotely.

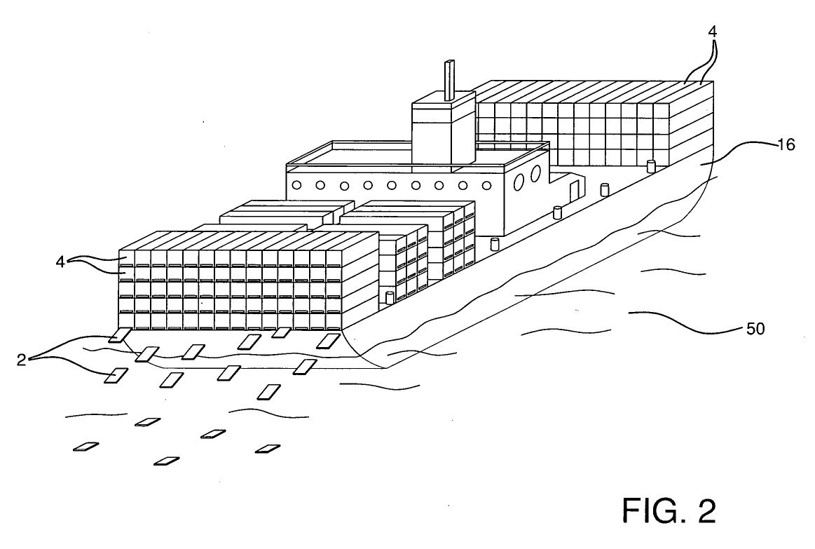

FIG. 2 shows a plurality of containers 4 being positioned on marine vessel 16 and the general manner in which agar sheets 2 are to be dispensed from the vessel onto the surface of a body of water 50.

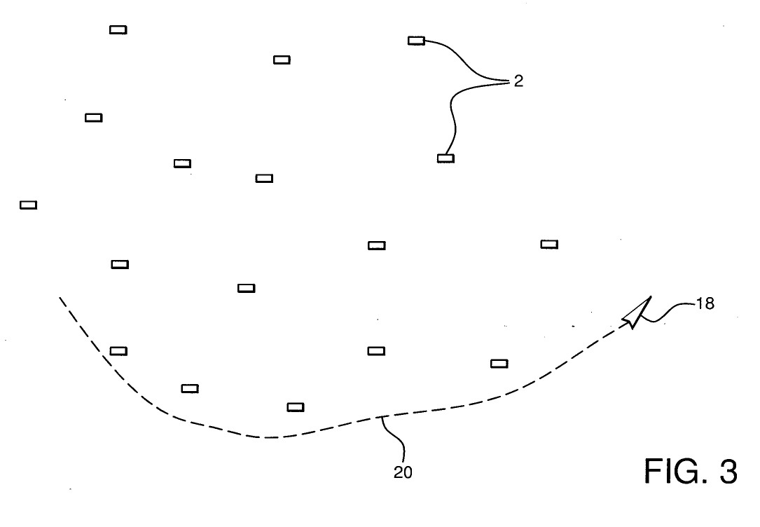

It is contemplated that vessel 16 will be dispatched to a body of water location, optimally in the ocean where low-iron/low-algae densities also coincide with an area of the ocean where relatively consistent directional ocean surface currents exist. As seen in FIG. 3, boundary containment booms 20 can be dispensed and positioned, for instance from the stem of high speed vessels 18, so that they are aligned along the contours of ocean current lines, approximately parallel to the directional current flow.

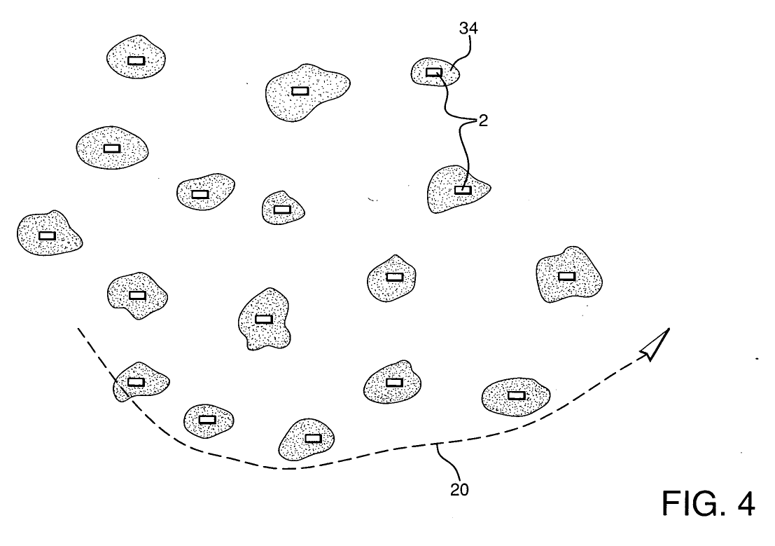

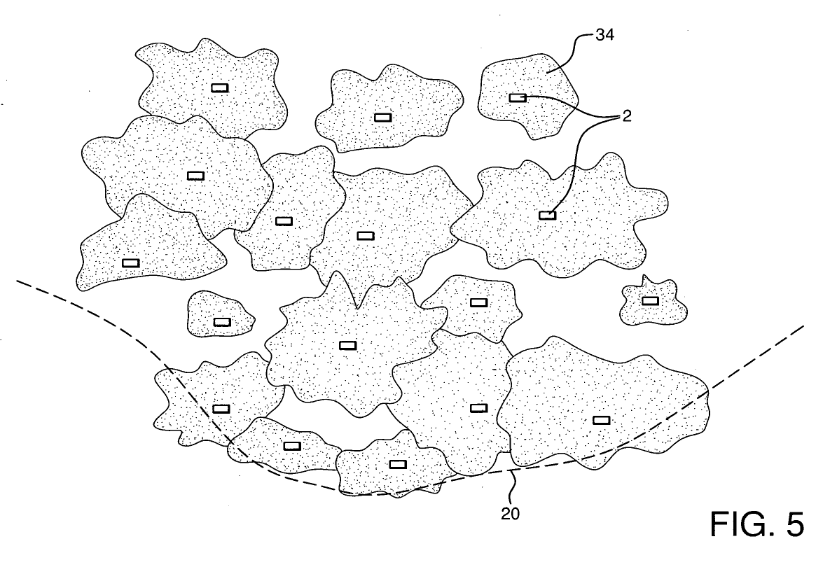

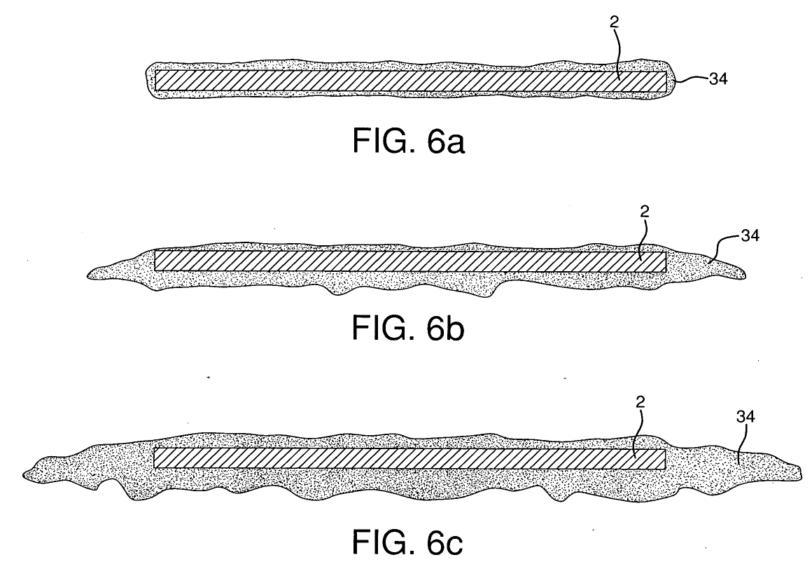

Agar sheets 2 are dispensed from vessel 16 onto the surface of the body of water 50, in a predetermined pattern, for instance as shown in FIG. 3. Microalgae growth 34 begins immediately on and around agar sheets 2. This growth continues in varying degrees, for instance over a period of approximately ten hours, FIG. 6a, twenty hours, 6b, and thirty hours, 6c of microalgae growth 34. FIGS. 4 and 5 show anticipated growth of microalgae 34 on and around agar sheets 2 after several days and after approximately one week.

Of course, as a result of this rapid growth of the microalgae, massive quantities of carbon dioxide will be absorbed and oxygen will be expelled into the atmosphere.

When microalgae growth reaches the stage such as is shown in FIG. 5, agar sheets 2 are retrieved by crane or equivalent lifting device from the surface of body of water, ocean 50. Microalgae growth 34 is ultimately separated from agar sheets 2 and processed, as previously described, for biodiesel fuels and other uses. Agar sheets 2 are then rehabilitated and returned for redeployment on the ocean surface. It is also contemplated that it may be more cost effective or desirable to compose agar sheets 2 so that they will be consumed and subsumed by the growing microalgae, so that the sheets become part of the algae for ultimate biodiesel fuel. This would eliminate the agar sheet recycling process and its associated costs.

It is further envisioned that a GPS-type tracking device could be embedded into each agar sheet, in order to reduce the number of vessels needed to monitor the locations of the sheets. These tracking devices will also be equipped with an alert signal, when the agar sheets stray beyond specified programmable coordinates. A receiving station vessel (mother ship) can then dispatch a high speed watercraft to intercept and redirect the stray biomass sheet. Containment booming can be mounted on the stem of each of such watercraft, to be used as a tail-whip to assist in herding the agar sheets back to their designated areas.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A method of atmospheric remediation comprising the steps of:
providing a biological growth medium;
forming the biological growth medium into preformed, gel-like sheets;
transporting the sheets to a location over a body of water;
distributing the sheets onto the surface of the body of water; and
growing carbon dioxide absorbing microalgae on the sheets.

2. The method of atmospheric remediation as in claim 1 comprising the further steps of heating the biological growth medium to a liquid state and then cooling the biological growth medium, prior to forming the biological growth medium into preformed gel-like sheets.

3. The method of atmospheric remediation as in claim 1 comprising the further step of adding at least one microalgae growth element to the biological growth medium prior to forming the biological growth medium into preformed gel-like sheets.

4. The method of atmospheric remediation as in claim 1 comprising the further step of retrieving the preformed sheets and separating the microalgae from the sheets.

5. The method of atmospheric remediation as in claim 4 comprising the further step of returning the preformed sheets to a location over a body of water.

6. The method of atmospheric remediation as in claim 4 comprising the further step of using the microalgae grown on and separated from the preformed sheets for the production of biofuel.

7. The method of atmospheric remediation as in claim 1 wherein the body of water location is a nutrient rich area.

8. The method of atmospheric remediation as in claim 1 wherein the biological growth medium comprises agar.

9. The method of atmospheric remediation as in claim 1 further comprising the step of adding multiple microalgae growth elements to the biological growth medium.

10. The method of atmospheric remediation as in claim 3 wherein the microalgae growth element comprises iron.

11. The method of atmospheric remediation as in claim 1 wherein the sheets are transported to the body of water location by a marine vessel.

12. The method of atmospheric remediation as in claim 1 comprising the further step of providing boundary booming to maintain the preformed sheets in a designated boomed area.

13. A method of atmospheric remediation comprising the steps of:
providing a biological growth medium;
transporting the biological growth medium to a location over a body of water;
distributing the biological growth medium over the surface of the body of water; and
growing carbon dioxide absorbing microalgae around the growth medium.

14. The method of atmospheric remediation as in claim 13 comprising the further step of adding at least one microalgae growth element to the biological growth medium.

15. The method of atmospheric remediation as in claim 14 wherein the body of water location is a nutrient rich area.

16. The method of atmospheric remediation as in claim 14 wherein the biological growth medium comprises agar.

17. The method of atmospheric remediation as in claim 13 further comprising the step of adding multiple microalgae growth elements to the biological growth medium.

18. The method of atmospheric remediation as in claim 14 wherein the microalgae growth element comprises iron.

19. The method of atmospheric remediation as in claim 14 comprising the further step of providing boundary booming to maintain the preformed sheets in a designated boomed area.

20. An atmospheric remediation system comprising:
a plurality of preformed, gel-like sheet means comprising a biological growth medium and at least one microalgae growth element for stimulating microalgae growth on the sheet means;
transportation means for conveying the preformed sheet means to designated locations over a body of water; and
distribution means for positioning the preformed sheet means onto the surface of the body of water locations, whereby placement of the sheet means on the surface of the body of water locations causes microalgae growth on the preformed sheet means.

21. The atmospheric remediation system as in claim 20 further comprising container means for the storage and ejection of the sheet means from the transportation means.

22. The atmospheric remediation system of claim 20 further comprising boundary booming for maintaining the sheet means in designated areas in the body of water locations.

23. The atmospheric remediation system as in claim 20 wherein the biological growth medium comprises agar.

24. The atmospheric remediation system as in claim 20 wherein the microalgae growth element comprises iron.

25. The atmospheric remediation system as in claim 20 wherein the biological growth medium comprises a plurality of microalgae growth elements.

26. An atmospheric remediation system comprising:
a plurality of preformed, gel-like sheets comprising a biological growth medium and at least one microalgae growth element;
a marine vessel for conveying the preformed sheets to designated locations over a body of water; and
means on the marine vessel for dispensing the preformed sheets onto the surface of the body of water in a predetermined pattern to promote microalgae growth on the preformed sheets.

27. The atmospheric remediation system as in claim 26 further comprising container means for the storage and ejection of the sheets from the marine vessel.

28. The atmospheric remediation system of claim 26 further comprising boundary booming for maintaining the sheets in designated areas in the body of water locations.

29. The atmospheric remediation system as in claim 26 wherein the biological growth medium comprises agar.

30. The atmospheric remediation system as in claim 26 wherein at least one microalgae growth element comprises iron.

31. The atmospheric remediation system as in claim 26 wherein the biological growth medium comprises a plurality of microalgae growth elements.
